(19) United States
(12) Patent Application Publication
(10) Pub. No.: US 2012/0028082 A1
(43) Pub. Date: Feb. 2, 2012

(54) Battery pack

(76) Inventors: Myung-Jun Lee, Yongin-si (KR); Seong-Joon Lee, Yongin-si (KR)

(21) Appl. No.: 13/067,544

(22) Filed: Jun. 8, 2011

(30) Foreign Application Priority Data
Jul. 28, 2010 (KR) 10-2010-0072972

(51) Int. Cl. H01M 10/42

(52) U.S. Cl. 429/7

(57) ABSTRACT

A battery pack including a cap plate; a bare cell, the bare cell being sealed by the cap plate; and a circuit board facing the cap plate, wherein the circuit board includes opening units adjacent to edges thereof, the opening units providing an opening for coupling the circuit board to the cap plate.

### BACKGROUND

1. Field

Embodiments relate to a battery pack.

2. Description of the Related Art

Due to technical development and production growth for mobile devices, e.g., mobile phones and laptop computers, demand for secondary batteries as energy sources has rapidly increased. Currently, as fossil fuel is being replaced, studies on use of secondary batteries in, e.g., electric vehicles and hybrid vehicles, are actively being carried out.

In general, secondary batteries may be used in the form of a battery pack including a circuit structure for controlling charging and discharging operations.

### SUMMARY

Embodiments are directed to a battery pack.

At least one of the above and other features and advantages may be realized by providing a battery pack including a cap plate; a bare cell, the bare cell being sealed by the cap plate; and a circuit board facing the cap plate, wherein the circuit board includes opening units adjacent to edges thereof, the opening units providing an opening for coupling the circuit board to the cap plate.

The opening units may have a closed hole structure surrounded by sidewalls of the circuit board.

The opening units may have an open groove structure in which sides of the circuit board around the opening units are open toward an outside of the circuit board.

The battery pack may further include combining members between the opening units and the cap plate.

The combining members may include metal plates fixed to the circuit board.

The combining members and the cap plate may be welded at welding regions corresponding to the opening units.

The circuit board may include a pair of opening units, the pair of opening units being at opposite edges of the circuit board.

The circuit board may include a terminal hole at a center thereof, the terminal hole exposing an electrode terminal of the cap plate.

The battery pack may further include a PTC device, the PTC device having one end connected to the circuit board and another end connected to the electrode terminal exposed through the terminal hole.

The battery pack may further include an external connection terminal on the circuit board, the external connection terminal including at least two separate terminals spaced apart from each other by gap spaces.

The external connection terminal may have a first height from the circuit board, a PTC device on the circuit board may have a second height from the circuit board, and the first height may be greater than the second height.

The circuit board may include a first surface facing the cap plate and a second surface opposite to the first surface, combining members on the first surface of the circuit board and corresponding to the opening units, the combining members coupling the circuit board to the cap plate, and a PTC device and an external connection terminal on the second surface of the circuit board.

At least one of the above and other features and advantages may also be realized by providing a battery pack including a cap plate; a bare cell, the bare cell being sealed by the cap plate; a circuit board on the cap plate; and an external connection terminal on the circuit board, wherein the external connection terminal includes at least two separate terminals spaced apart from each other by gap spaces.

The external connection terminal may include first and second power source terminals, the first and second power source terminals each having a first width; and a signal transmission terminal between the first and second power source terminals, the signal transmission terminal having a second width, wherein the second width is narrower than the first widths.

The external connection terminal may include metal blocks on the circuit board.

The external connection terminal may include patterned terminal patterns on the circuit board.

The terminal patterns may be formed from a raw material paste.

The circuit board may include opening units on edges thereof, the opening units providing an opening for coupling the circuit board to the cap plate.

The battery pack may further include combining members on the circuit board between the opening units and the cap plate.

The combining members and the cap plate may be coupled by welding through the opening units of the circuit board.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a battery pack according to an embodiment;

FIG. 2 illustrates an exploded perspective view of a part of the battery pack of FIG. 1;

FIG. 3 illustrates a cross-sectional view of the part of FIG. 2 taken along a line III-III;

FIG. 4 illustrates a cross-sectional view of a protective circuit module in an assembling state;

FIG. 5 illustrates a plan view of the protective circuit module of FIG. 4;

FIGS. 6 and 7 illustrate perspective views of external connection terminals according to embodiments;

FIG. 8 illustrates an exploded perspective view of an external connection terminal according to a comparative example;

FIG. 9 illustrates an exploded perspective view of a battery pack according to another embodiment;

FIG. 10 illustrates an exploded perspective view of a battery pack according to yet another embodiment; and

FIG. 11 illustrates a plan view of a protective circuit module of FIG. 10.

### DETAILED DESCRIPTION

Korean Patent Application No. 10-2010-0072972, filed on Jul. 28, 2010, in the Korean Intellectual Property Office, and entitled: “Battery Pack,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

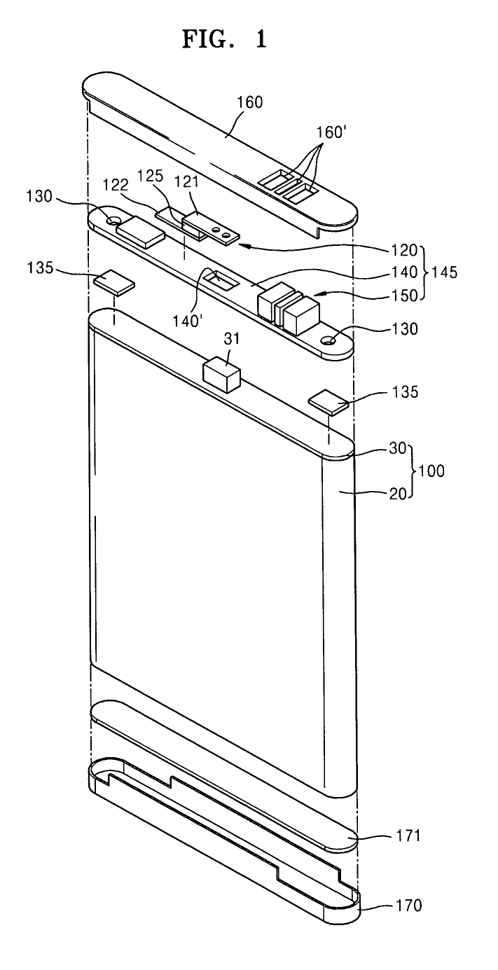

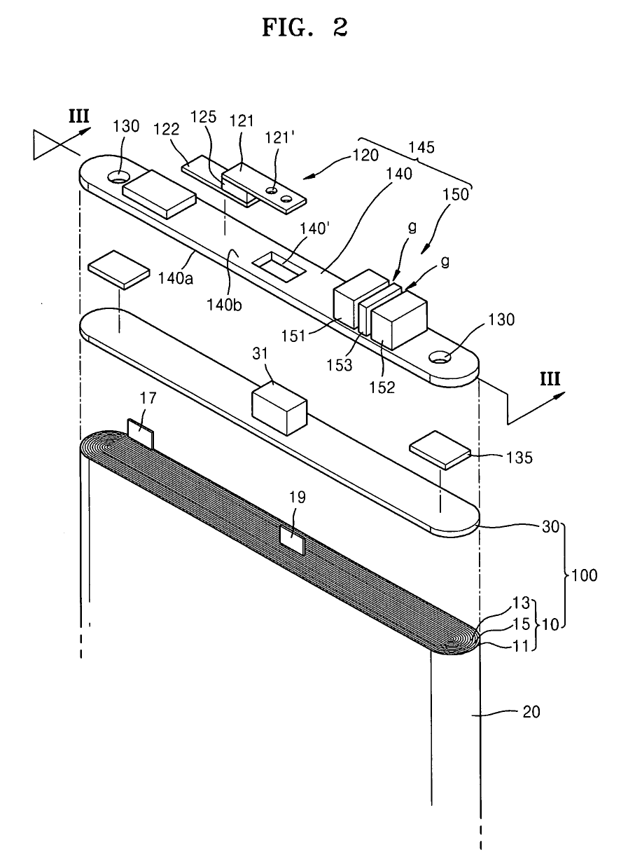

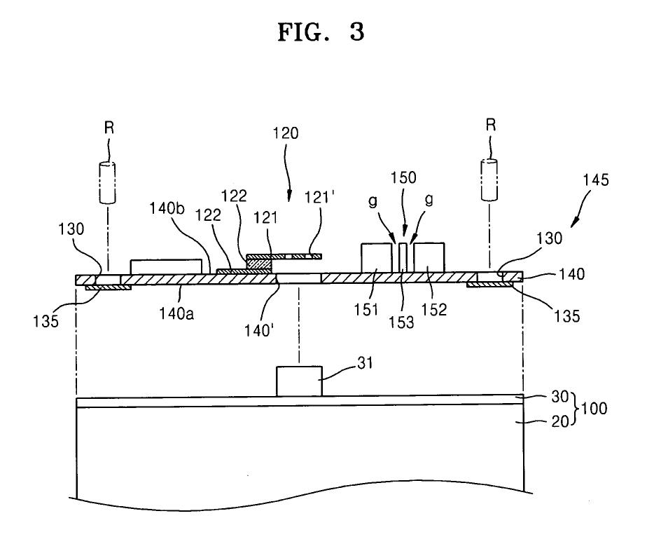

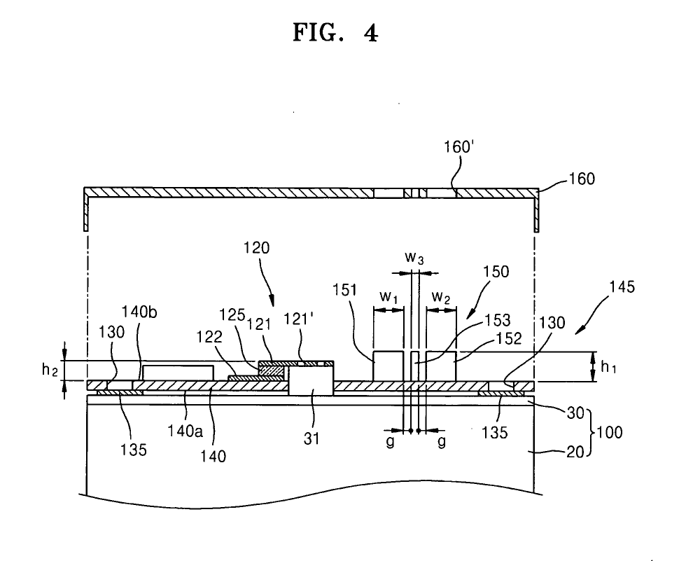

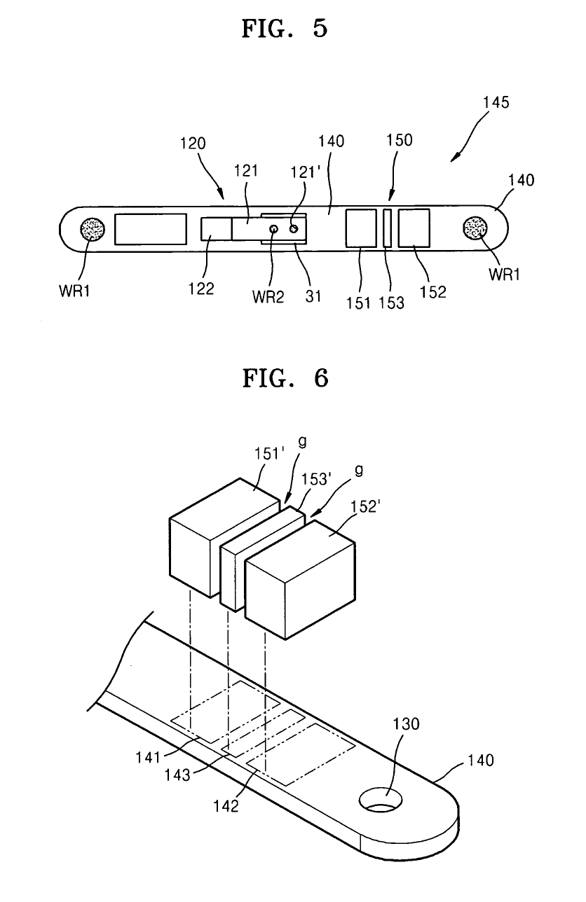

Hereinafter, embodiments will be described in more detail with reference to the accompanying drawings. FIG. 1 illustrates an exploded perspective view of a battery pack according to an embodiment. FIG. 2 illustrates an exploded perspective view of a part of the battery pack of FIG. 1. FIG. 3 illustrates a cross-sectional view of the part of FIG. 2 taken along a line FIG. 4 illustrates a cross-sectional view of a protective circuit module in an assembling state. FIG. 5 illustrates a plan view of the protective circuit module of FIG. 4.

The battery pack may include a bare cell 100 having an electricity generation element and a protective circuit module (PCM) 145 on the bare cell 100. The PCM 145 may control charging and discharging operations of the bare cell 100.

The bare cell 100 may include a rechargeable secondary battery, e.g., a lithium-ion cell. As illustrated in FIG. 2, the bare cell 100 may be formed by sealing an electrode assembly 10 including a positive electrode plate 11, a negative electrode plate 13, and a separator 15 in a can 20 with an electrolyte (not illustrated). For example, the bare cell 100 may include the electrode assembly 10 as a jelly roll structure formed by rolling a stack body including the positive electrode plate 11, the negative electrode plate 13, and the separator 15, the can 20 having an open upper side for accommodating the electrode assembly 10 and the electrolyte, and a cap plate 30 for sealing the upper side of the can 20. An airtight bond may be formed between the cap plate 30 and the can 20 using, e.g., laser welding.

A positive electrode tab 17 and a negative electrode tab 19 may be respectively connected to the positive electrode plate 11 and the negative electrode plate 13. For example, the positive electrode tab 17 may be directly connected to the cap plate 30; and the negative electrode tab 19 may be connected to an electrode terminal 31 protruding from the cap plate 30. An insulation bond may be formed between the electrode terminal 31 and the cap plate 30; and the electrode terminal 31 may protrude from the cap plate 30.

The PCM 145 may control charging and discharging operations of the bare cell 100. When an excessive current, e.g., above a predetermined threshold value, flows through the PCM 145, when a temperature of the bare cell 100 increases above a set temperature, and/or when the bare cell 100 is excessively charged or discharged, the PCM 145 may block a current flow therethrough and may perform a protective operation for protecting the bare cell 100. For example, the PCM 145 may include a circuit board 140, a positive temperature coefficient PTC device 120, and an external connection terminal 150. The circuit board 140 may include a sensing circuit (not illustrated) for detecting state information, e.g., in regards to current, voltage, and the like, and/or a charging and discharging protective circuit (not illustrated). The PTC device 120 may be installed on the circuit board 140 and may control a charging or discharging current according to an increase of temperature. The external connection terminal 150 may be installed on the circuit board 140 and may relay an electric connection with an external device (not illustrated). In this regard, the PCM 145 may include passive devices, e.g., a charging and discharging switching device (field effect transistor (FET), a capacitor, and a resistor.

The PTC device 120 may form a current path between the electrode terminal 31 of the cap plate 30 and the circuit board 140. When a temperature of the bare cell 100 exceeds a set threshold value, an electric resistance of the PTC device 120 may increase. Accordingly, the PTC device 120 may reduce a charging or discharging current. For example, the PTC device 120 may include a variable resistor 125 and first and second lead members 121 and 122 such that an electric resistance of the variable resistor 125 may be changed according to temperature. The first and second lead members 121 and 122 may be formed on an upper side and a lower side of the variable resistor 125, respectively, and may extend in different directions. For example, the first lead member 121 may be connected to the electrode terminal 31, which may penetrate the circuit board 140 and may protrude from the circuit board 140. The second lead member 122 may be connected to the circuit board 140.

A terminal hole 140′ exposing the electrode terminal 31 may be formed on, e.g., a center, of the circuit board 140. For example, the electrode terminal 31 exposed through the terminal hole 140′ may be connected to the PTC device 120. For example, the electrode terminal 31 may be connected to the first lead member 121 of the PTC device 120. The electrode terminal 31 and the PTC device 120 may be bonded to each other by, e.g., welding. For example, a welding hole 121′ may be formed on the first lead member 121 of the PTC device 120. In an implementation, the first lead member 121 and the electrode terminal 31 may be bonded to each other by welding the first lead member 121 and the electrode terminal 31 at the welding hole 121′.

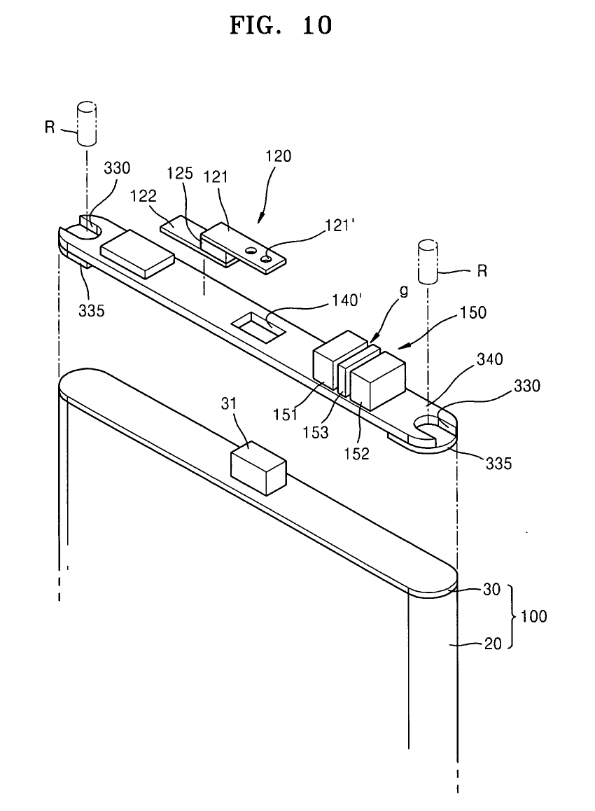

Opening units 130 of the circuit board 140 may be used when coupling, e.g., welding, the cap plate 30 to the circuit board 140. The opening units 130 may be formed at, e.g., edges of the circuit board 140, and may be formed as a pair symmetric with each other. In an implementation, the opening units 130 may be formed as holes surrounded by side walls of the circuit board 140, e.g., closed holes penetrating and completely enclosed by the circuit board 140. In another implementation, the opening units 130 may be formed as, e.g., open, holes in which sides of the circuit board 140 around the opening units 130 are open toward the outside of the circuit board 140, e.g., may be formed as open grooves (see FIG. 10).

Combining members 135 may be interposed between the circuit board 140 and the cap plate 30. For example, the combining members 135 may correspond to the opening units 130 of the circuit board 140, may be fixed on lower sides of the circuit board 140, and may contact the cap plate 30. The combining members 135 may each include a metal plate and may each be formed of the same metal as the cap plate 30 in consideration of welding strength with the cap plate 30.

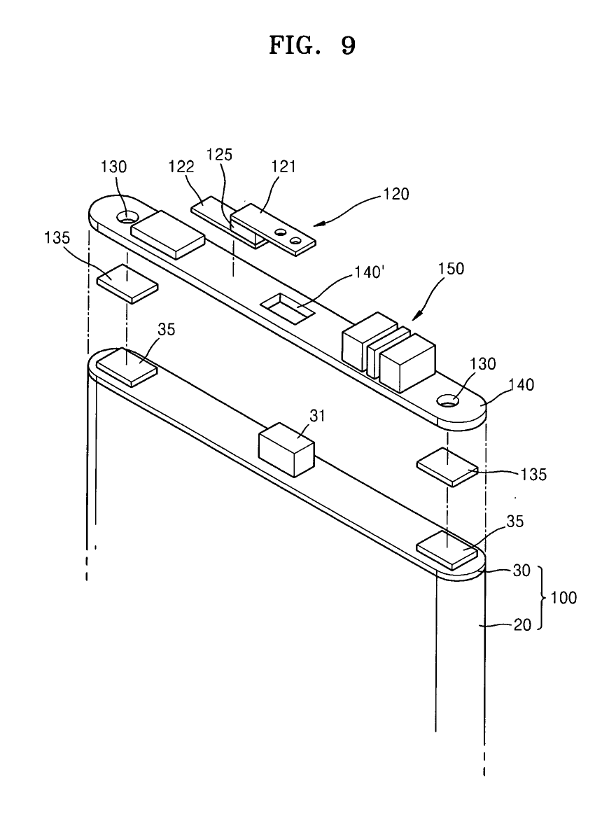

The combining members 135 may be coupled, e.g., welded, to the cap plate 30 through the opening units 130 of the circuit board 140. As illustrated in FIG. 3, the opening units 130 of the circuit board 140 may provide paths for a welding tool R, e.g., a pole electrode for welding. The combining members 135 and portions of the cap plate 30 in contact therewith may be coupled to each other by, e.g., welding, through the opening unit 130. In an implementation, the combining members 135 may be directly welded to the cap plate 30. In another implementation, the combining members 135 may be welded to separate additional members 35 (see FIG. 9) attached on the cap plate 30 for protecting the cap plate 30. The combining members 135 may be directly welded to the cap plate 30 according to types of welding or types of welding heating source. Also, the combining members 135 may be welded to the cap plate 30 by using the separate additional members 35 for protecting the cap plate 30.

The external connection terminal 150 may relay an electrical connection with an external device. For example, the external connection terminal 150 may relay a current flow and a signal transmission/reception by forming an interface with an external load (e.g., a mobile device) or an external power supply device. For example, the external connection terminal 150 may include first and second power source terminals 151 and 152 each having a pattern with a relatively broad width and a signal transmission terminal 153 having a pattern with relatively narrow width. In an implementation, the widths of the first and second power source terminals 151 and 152 may each be wider than the width of the signal transmission terminal 153. The first and second power source terminals 151 and 152 may include a positive electrode terminal and a negative electrode terminal, respectively, and may form an electric interface with an external device for inputting and outputting charging and discharging currents.

In an implementation, the first and second power source terminals 151 and 152 may form a charging and discharging integrated terminal. However, the embodiments are not limited thereto, and a charging terminal and a discharging terminal may be separately formed or a charging and discharging terminal may be integrated or separated according to polarity. In this regard, the number and form of the external connection terminal 150 are not limited to the above.

The signal transmission terminal 153 may be, e.g., interposed between the first power source terminal 151 and the second power source terminal 152, and may form an electric interface for communicating data with an external device. The signal transmission terminal 153 may receive a control signal related to a charging or discharging operation from an external device or may transmit state information about, e.g., voltage, current, and/or temperature, measured in the battery pack to an external device. The signal transmission terminal 153 may form a data transmission path to an external device; and one or more signal transmission terminals 153 may be included, if desired.

Referring to FIG. 4, the first and second power source terminals 151 and 152 may form a power transmission line and may have widths W1 and W2, respectively, which may help prevent power loss according to resistances thereof. The signal transmission terminal 153 may form a signal transmission line and may have a width W3, which may help save or preserve mounting space on the circuit board 140.

The external connection terminal 150 may protrude from the circuit board 140 by a first height h1. For example, a top cover 160 may be coupled to the PCM 145; and the top cover 160 may receive the PCM 145 and couple to the bare cell 100, thereby protecting the PCM 145. In an implementation, the external connection terminal 150 protruding from the circuit board 140 by the first height h1 may be exposed to the outside through an opening pattern 160′ of the top cover 160 and thus may maintain a stable connection with an external device.

In an implementation, the first height h1 of the external connection terminal 150 may be higher than a second height h2 of the PTC device 120. Accordingly, the external connection terminal 150 may be exposed to the outside from the top cover 160 and may be stably connected to an external device, whereas the PTC device 120 may be covered by the top cover 160 and protected by the top cover 160. In an implementation, the second height h2 may be, e.g., a height of the first lead member 121 of the PTC device 120 coupled to the electrode terminal 31. For example, the height h2 may be a height from a top surface of the circuit board 140 to a top surface of the first lead member 121.

The external connection terminal 150 may be formed by mounting a plurality of metal blocks in a terminal area of the circuit board 140. In an implementation, the metal blocks may separately correspond to the first and second power source terminals 151 and 152 and the signal transmission terminal 153 for forming the external connection terminal 150. Thus, the first and second power source terminals 151 and 152 and the signal transmission terminal 153 may be electrically insulated from each other.

Referring to FIG. 4, the, e.g., thin, combining members 135 may be interposed between the circuit board 140 and the cap plate 30 and any spare space for containing elements other than the combining members 135 may not be required. Accordingly, a space for installing the PCM 145 may be small; and an upper space of the cap plate 30 over the PCM 145 may also be small so that the battery pack may be compact. For example, the combining members 135 may be formed on a first surface 140a of the circuit board 140 that faces the cap plate 30; and the PTC device 120 and the external connection terminal 150 may be formed on a second surface 140b that is opposite to the first surface 140a. Accordingly, the battery pack may be slim and compact.

In a comparative example, a lead member bent in the form of steps may be interposed between the circuit board and the cap plate. One end and another end of the lead member may contact a lower surface of the circuit board and an upper surface of the cap plate, respectively. In this regard, a volume of the battery pack may increase due to space taken by the lead member. Also, a PTC device or an external connection terminal may be disposed in the space secured by the lead member, e.g., between the cap plate and circuit board. Thus, assembling strength may decrease according to a height of the lead member and an arrangement of other elements. For example, elements may not be tightly assembled and there may be spaces between the elements. However, according to an embodiment, a combined structure of the circuit board 140 and the cap plate 30 may be improved and overall volume of the battery pack may be reduced and elements of the battery pack may be tightly assembled through compact packing. Accordingly, assembling strength may be improved.

An insulating label sheet (not illustrated) may be attached along an outer circumference of the bare cell 100; and an adhesive member 171 of FIG. 1, e.g., a double-sided tape, may be attached on a bottom of the bare cell 100 so that a lower cover 170 may be coupled to the bare cell 100.

As illustrated in FIG. 5, WR1 represents a first welding area between the combining member 135 and the cap plate 30; and WR2 represents a second welding area between the first lead member 121 of the PTC device 120 and the electrode terminal 31. In an implementation, portions of the combining member 135 exposed through the opening units 130 may be heated by the welding tool R and may be welded to the cap plate 30.

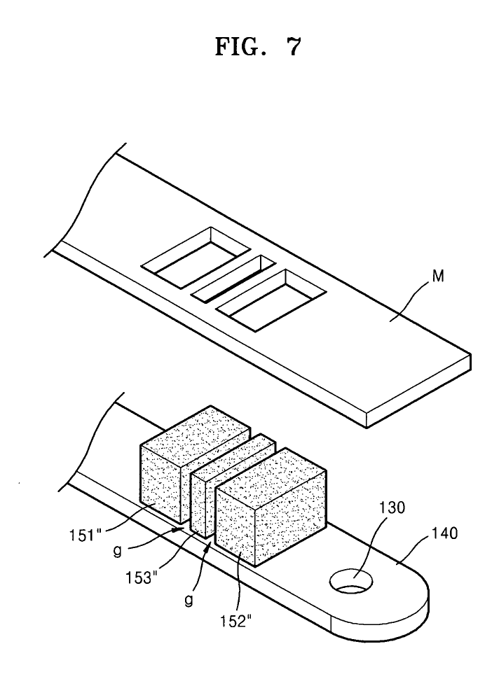

FIGS. 6 and 7 illustrate perspective views of the external connection terminals 150 according to the embodiments. As illustrated in FIG. 6, a metal material having excellent electric conductivity may be processed in a block unit so as to form blocks 151′ and 152′ for the first and second power source terminals 151 and 152 and a block 153′ for the signal transmission terminal 153. The metal blocks 151′,152′, and 153′ may be respectively formed on contact pads 141,142, and 143 spaced apart from each other on the circuit board 140 to insulate the first and second power source terminals 151 and 152 and the signal transmission terminal 153 from each other. For example, the metal blocks 151′,152′, and 153′ may be coupled to the contact pads 141,142, and 143 of the circuit board 140 by soldering, welding, or other conductive methods, e.g., using a conductive adhesive (not illustrated). The metal blocks 151′, 152′, and 153′ may have a rectangular or cuboid shape or may have other three dimensional shapes.

As illustrated in FIG. 7, the external connection terminal 150 may include terminal patterns 151″, 152″ and 153″ on the circuit board 140. For example, the terminal patterns 151″, 152″, and 153″ may be formed by coating a powder or paste raw material on a terminal area of the circuit board 140 through a pattern mask M. If desired, a hardening process may be performed after coating the raw material.

Alternatively, a hardening process for the raw material entirely or continuously coated on the terminal area of the circuit board 140 may be selectively performed by using the pattern mask M so that a hardened part and a non-hardened part may be formed according to patterns defined by the pattern mask M. Then, the non-hardened part may be removed by, e.g., etching, thereby forming the terminal patterns 151″, 152″, and 153″. For example, the hardening process may include UV light hardening.

The external connection terminal 150 formed as described above may include the first and second power source terminals 151 and 152 and the signal transmission terminal 153 spaced apart from each other by gap spaces g, as illustrated in FIG. 4. The first and second power source terminals 151 and 152 and the signal transmission terminal 153 may be insulated from each other by the gap spaces g therebetween.

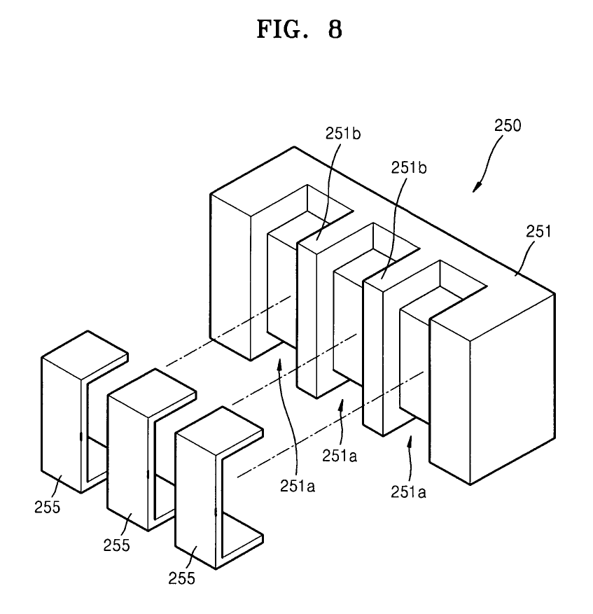

FIG. 8 illustrates an exploded perspective view of an external connection terminal 250 according to a comparative example. Referring to FIG. 8, the external connection terminal 250 may include a terminal housing 251 and terminal units 255 inserted in and fixed to the terminal housing 251. The terminal housing 251 may form an external shape of the external connection terminal 250 and may include, e.g., an injection molding material formed of an insulating resin. The terminal housing 251 may include a plurality of assembling units 251a that define assembling positions of the terminal units 255. The terminal units 255 may each be inserted in to the assembling units 251a to cover the assembling units 251a and may be insulated from each other by boundary walls 251b.

The terminal units 255 may include a plurality of conductive metal pieces bent according to external forms of the assembling units 251a and may surround outer surfaces of the assembling units 251a. The plurality of metal pieces corresponding to power source terminals and a signal transmission terminal may each be inserted into and fixed to the assembling units 251a. The terminal units 255 inserted into the terminal housing 251 may be welded to a wiring pattern of a circuit board.

In the comparative example, heterogeneous materials, e.g., the insulating terminal housing 251 and the conductive terminal units 255, may be used to form the external connection terminal 250. The terminal units 255 may each be inserted into and fixed to the terminal housing 251 while being insulated from each other. However, according to the embodiments, the external connection terminal 150 may be formed by using a simple process for mounting the metal blocks in the terminal area of the circuit board 140; and the first and second power source terminals 151 and 152 and the signal transmission terminal 153 may be insulated from each other through the gap spaces g between the metal blocks. In this regard, the process of forming the external connection terminal 150 may be simple in the embodiments.

FIG. 9 illustrates an exploded perspective view of a battery pack according to another embodiment. In the battery pack, the opening units 130 may be formed on edges, e.g., opposite edges, of the circuit board 140; and the circuit board 140 may be coupled to the cap plate 30 by, e.g., welding through the opening units 130. In an implementation, the combining members 135 may be interposed between the circuit board 140 and the cap plate 30. The combining members 135 may be fixed to the lower surface of the circuit board 140 and may correspond to the opening units 130 so as to face the cap plate 30.

For example, the opening units 130 may provide entering paths for a welding tool; and the combining members 135 and portions of the cap plate 30 in contact therewith may be coupled to each other by welding through the opening units 130. As described above, the combining members 135 may be directly welded to the cap plate 30. However, as illustrated in FIG. 9, the combining members 135 may be welded to separate additional members 35 coupled to the cap plate 30 for protecting the cap plate 30. Thus, the combining members 135 may be welded to the cap plate 30 by using the separate additional members 35 for protecting the cap plate 30.

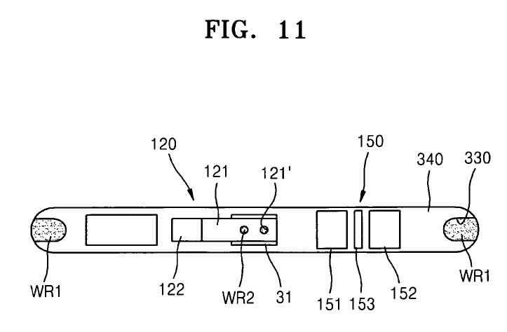

FIG. 10 illustrates an exploded perspective view of a battery pack according to yet another embodiment. FIG. 11 illustrates a plan view of a protective circuit module of FIG. 10.

In the battery pack, opening units 330 may be formed on edges of a circuit board 340. For example, the opening units 330 may be formed on opposite edges of the circuit board 340 and may be formed as holes or grooves in which sides of the circuit board 340 adjacent to the opening units 330 are open toward the outside of the circuit board 340. For example, the opening units 330 may have the form of holes or grooves in which at least one side thereof is open, instead of holes entirely enclosed by side walls of the circuit board (see FIG. 1).

Combining members 335 may be fixed to a lower surface of the circuit board 340 corresponding to the opening units 330 and may face the cap plate 30. For example, the combining members 335 may be aligned with both ends of the circuit board 340.

For example, the opening units 330 may provide entering paths for a welding tool R; and the combining members 335 and portions of the cap plate 30 in contact therewith may be coupled to each other by welding through the opening units 330. As illustrated in FIG. 11 WR1 represents a first welding area between the combining members 335 and the cap plate 30; and WR2 represents a second welding area between the first lead member 121 of the PTC device 120 and the electrode terminal 31. In an implementation, portions of the combining member 335 exposed through the opening units 330 may be heated by the welding tool R and may be welded to the cap plate 30.

In consideration of stability of secondary batteries including combustible materials, a circuit structure for efficiently controlling abnormalities, e.g., excessive charge, excessive discharge, excessive current, and the like may be included in the secondary battery.

As described above, according to the embodiments, a coupling structure between a cap plate that seals a bare cell and a circuit board on the cap plate may be improved so that a battery pack may be compact and may have improved assembling strength.

In addition, according to the embodiments, a structure of an external connection terminal that relays power supply and data communication with an external device may be improved so that a process of forming a battery pack may be simplified.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery pack, comprising:
a cap plate;
a bare cell, the bare cell being sealed by the cap plate; and
a circuit board facing the cap plate,
wherein the circuit board includes opening units adjacent to edges thereof, the opening units providing an opening for coupling the circuit board to the cap plate.

2. The battery pack as claimed in claim 1, wherein the opening units have a closed hole structure surrounded by sidewalls of the circuit board.

3. The battery pack as claimed in claim 1, wherein the opening units have an open groove structure in which sides of the circuit board around the opening units are open toward an outside of the circuit board.

4. The battery pack as claimed in claim 1, further comprising combining members between the opening units and the cap plate.

5. The battery pack as claimed in claim 4, wherein the combining members include metal plates fixed to the circuit board.

6. The battery pack as claimed in claim 4, wherein the combining members and the cap plate are welded at welding regions corresponding to the opening units.

7. The battery pack as claimed in claim 1, wherein the circuit board includes a pair of opening units, the pair of opening units being at opposite edges of the circuit board.

8. The battery pack as claimed in claim 1, wherein the circuit board includes a terminal hole at a center thereof, the terminal hole exposing an electrode terminal of the cap plate.

9. The battery pack as claimed in claim 8, further comprising a PTC device, the PTC device having one end connected to the circuit board and another end connected to the electrode terminal exposed through the terminal hole.

10. The battery pack as claimed in claim 1, further comprising an external connection terminal on the circuit board, the external connection terminal including at least two separate terminals spaced apart from each other by gap spaces.

11. The battery pack as claimed in claim 10, wherein:
the external connection terminal has a first height from the circuit board,
a PTC device on the circuit board has a second height from the circuit board, and
the first height is greater than the second height.

12. The battery pack as claimed in claim 1, wherein the circuit board includes:
a first surface facing the cap plate and a second surface opposite to the first surface,
combining members on the first surface of the circuit board and corresponding to the opening units, the combining members coupling the circuit board to the cap plate, and
a PTC device and an external connection terminal on the second surface of the circuit board.

13. A battery pack, comprising:
a cap plate;
a bare cell, the bare cell being sealed by the cap plate;
a circuit board on the cap plate; and
an external connection terminal on the circuit board,
wherein the external connection terminal includes at least two separate terminals spaced apart from each other by gap spaces.

14. The battery pack as claimed in claim 13, wherein the external connection terminal includes:
first and second power source terminals, the first and second power source terminals each having a first width; and
a signal transmission terminal between the first and second power source terminals, the signal transmission terminal having a second width, wherein the second width is narrower than the first widths.

15. The battery pack as claimed in claim 13, wherein the external connection terminal includes metal blocks on the circuit board.

16. The battery pack as claimed in claim 13, wherein the external connection terminal includes patterned terminal patterns on the circuit board.

17. The battery pack as claimed in claim 16, wherein the terminal patterns are formed from a raw material paste.

18. The battery pack as claimed in claim 13, wherein the circuit board includes opening units on edges thereof, the opening units providing an opening for coupling the circuit board to the cap plate.

19. The battery pack as claimed in claim 18, further comprising combining members on the circuit board between the opening units and the cap plate.

20. The battery pack as claimed in claim 19, wherein the combining members and the cap plate are coupled by welding through the opening units of the circuit board.
